(19) United States
(12) Patent Application Publication
(10) Pub. No.: US 2018/0365263 A1
(43) Pub. Date: Dec. 20, 2018

(54) Synchronized Views for Cloud-Based File Collaboration

(71) Applicant: Zoho Corporation Private Limited, Pleasanton, CA (US)

(72) Inventors: Kirubhakaran Mohan, Naduveerapattu (IN); Srinivasan VenkataSubramanian, Madurai (IN); Sripathy Ramesh, Chennai (IN)

(21) Appl. No.: 16/001,894

(22) Filed: Jun. 6, 2018

Related U.S. Application Data
(60) Provisional application No. 62/521,165, filed on Jun. 16, 2017.

(51) Int. Cl. G06F 17/30; G06F 3/0481; H04L 29/06

(52) U.S. Cl. CPC G06F 17/30165; H04L 65/4053; G06F 17/30126; G06F 3/04817

(57) ABSTRACT

Collaboration software allows collaborators to view and edit shared electronic files maintained at a central server for storage in a central “cloud.” Collaborators viewing instances of the same file are provided links to the views of other collaborators engaged with the file. Accessing one of these links provides a picture-in-picture (PiP) window of the corresponding collaborator's view. The PiP window can be expanded to review and edit that portion of the shared file under the collaborator's consideration. A project view extends this functionality to collection of files. Collaborators viewing the project view are provided links to the views of other collaborators engaged with one or more files associated with a project.

### BACKGROUND

Collaboration software allows collaborators to view and edit shared electronic files maintained at a central server for storage in a central “cloud.” When multiple collaborators are viewing instances of the same file, a word-processing document, spreadsheet, or presentation for example, collaboration software can assign each collaborator a color for highlighting their edits and comments.

### BRIEF DESCRIPTION OF THE DRAWINGS

The detailed description is illustrated by way of example, and not by way of limitation, in the figures of the accompanying drawings and in which like reference numerals refer to similar elements and in which:

FIG. 1 illustrates a method 100 by which changes to at least one shared electronic file 105 in a server 110 can be presented to multiple client devices 115 and 120 assigned to first and second file collaborators C1 and C2.

FIG. 2 depicts a window representing a collaborative spreadsheet 200 that lists a series of hypothetical tasks to be accomplished by a team or teams of collaborators.

FIG. 3 depicts a window 300 representing a user interface allowing collaborative access to a directory structure and constituent electronic files and folders.

FIG. 4 is a flowchart 400 illustrating how a client device interacts with a server to share users' views in accordance with one embodiment.

FIG. 5 is a flowchart 500 illustrating how a client device interacts with a server to gather and depict lists of collaborators and corresponding collaborator views in accordance with one embodiment.

FIG. 6 is a flowchart 600 illustrating how a client device submits an edit to a collaborative file on the server, and how the server manages this edit and those from other collaborators to maintain collaborative file synchronization between clients.

FIG. 7 (prior art) depicts a general-purpose computing system 700 that can serve as a client or a server depending on the program modules and components included.

### DETAILED DESCRIPTION

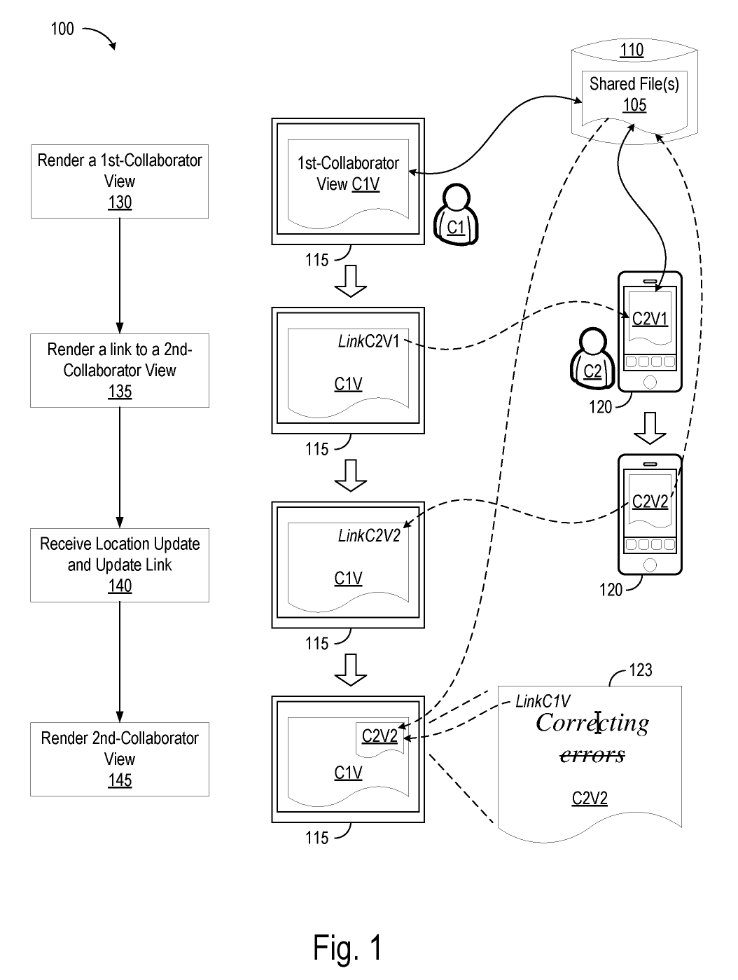

FIG. 1 illustrates a method 100 by which changes to at least one shared electronic file 105 in a server 110 can be presented to multiple client devices 115 and 120 assigned to first and second file collaborators C1 and C2. Multiple instances of each client device show progressive changes in the information displayed thereon. Client devices 115 and 120 are respectively a laptop computer and smart phone in this illustration but either or both can be different types of computing devices.

Client device 115 renders and displays a first-collaborator view C1V of shared file 105 (step 130). View C1V, also called a “viewport,” depicts a first area that represents all or a portion of file 105, one page of a multi-page document for example. In this embodiment a view refers to the visible area of a collaboration file on a user interface, which can be expected to show only a portion of the file. Client device 120 renders and displays a second-collaborator view C2V1 that allows second collaborator C2 to interact with a local instance of shared file 105. Second-collaborator view C2V1 depicts a second area that represents all or a portion of file 105, likely a different area from the one depicted in view C1V to collaborator C1. Rendered views from either or both clients 115 and 120 can be sent to a remote display instead of or in addition to a local display.

Client devices 115 and 120 periodically communicate with server 110 to synchronize client instances of shared file 105 with the cloud version maintained on and by server 110. In one embodiment this communication additionally alerts server 110 of the cursor position for each collaborator within their respective views. As a result, client 115 is able to receive linking information pointing to the portion of shared file 105 representative of second-collaborator view C2V1 on device 120, and to render a link LinkC2V1 to this view (135). Link LinkC2V1, a hyperlink in this example, can be displayed in association with something to identify collaborator C2, such as a name and color identifier (links are illustrated in italics). Link LinkC2V1 can also identify the view position of collaborator C2, such as the line, page, and document under consideration. First collaborator C1 can interact with link LinkC2V1 to call up a view of that material.

Second collaborator C2 is likely to move throughout or between documents, such as from view C2V1 to a different view C2V2. When this happens client device 120 updates server 110 with the new view position and server 110 shares this view-position information with client device 115. Upon receiving the view-position update, client device 115 updates the link to a second link LinkC2V2, the updated link reflecting the changed view of second collaborator C2 (140). Should first collaborator C1 select link LinkC2V2, client device 115 presents the second view C2V2 within first view C1V to allow collaborator C1 to e.g. consider changes by second collaborator C2.

The second collaborator's Second view C2V2 is presented as a picture-in-picture (PiP) within first view C1V in this example but other or additional schemes can be used. Collaborator C1 can expand the view C2V2 to provide an editing window 123 by selecting the PiP window. In this example window 123 illustrates a change as strike-through text “error” and marks an edit position using a cursor in the word “Correcting.” Window 123 can include a link LinkC1V back to the recent view C1V of collaborator C1. Window 123 could also include a PiP window of view C1V instead of or in addition to the link, allowing collaborator C1 to easily move between collaborative views. Second view C2V2 within first view C1V (e.g. as a PiP) need not match or have the same area or boundary as second-collaborator view C2V1 on client device 120 to capture the current view-position information (e.g. cursor position or scroll position) of collaborator C2.

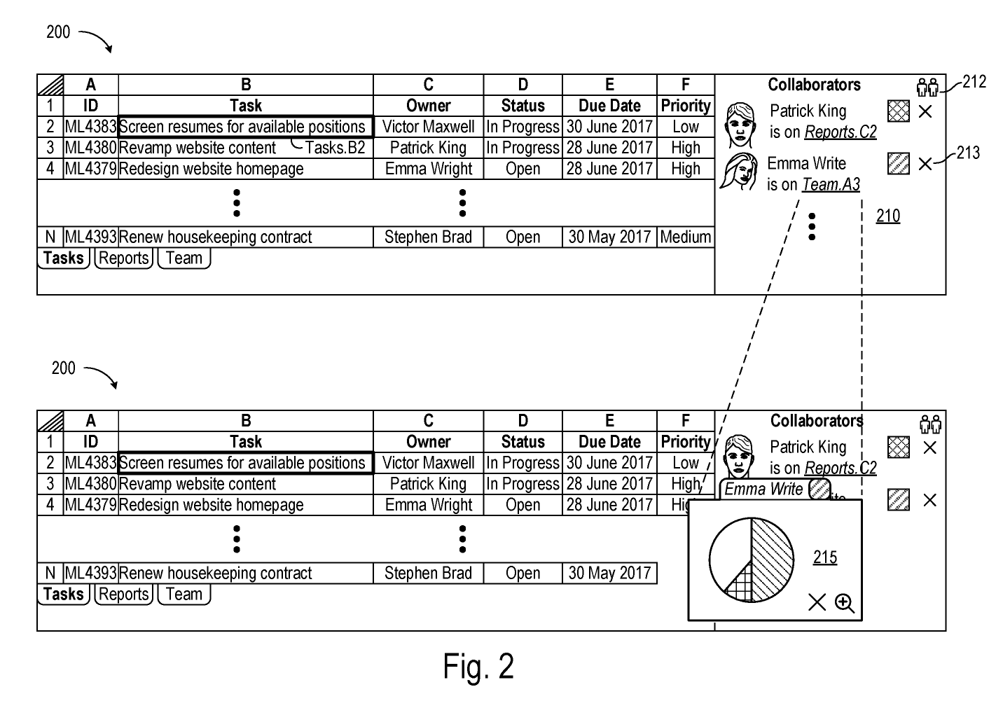

FIG. 2 depicts a window representing a collaborative spreadsheet 200 that lists a series of hypothetical tasks to be accomplished by a team or teams of collaborators. Spreadsheet 200 has three sheets Tasks, Reports, and Team, selectable via tabs at bottom. Bold borders surrounding a cell Tasks.B2 indicate that this cell is selected to undergo editing by collaborator and file owner Victor Maxwell.

A window 210 at the upper right lists users who have collaborative access (collaborators) to spreadsheet 200. These collaborators, Patrick King and Emma Write in this example, are each identified by a respective photo and their actions and edits highlighted using a shading or color. A hyperlink associated with each active collaborator identifies a view of that collaborator. In this example, link Reports.C2 indicates that collaborator Patrick King is viewing a cell C2 on sheet Reports and link Team.A3 that Emma Write is viewing a cell A3 on the sheet Team. Icons 212 and 213 allow the file owner to invite or disinvite collaborators to the file. These and other file permissions can be managed conventionally.

Selecting a collaborator link calls up a PiP window depicting the collaborator's view. In the instant example, Victor Maxwell selects link Team.A3 to call up a window 215 showing the contents of cell Team.A3 and related information, possibly highlighting Emma Write's changes. Collaborator Maxwell can interact with icons at the lower right of window 215 to close window 215, or to expand window 215 to facilitate collaborative viewing and editing of the same sheet. Multiple PiP windows can be displayed simultaneously.

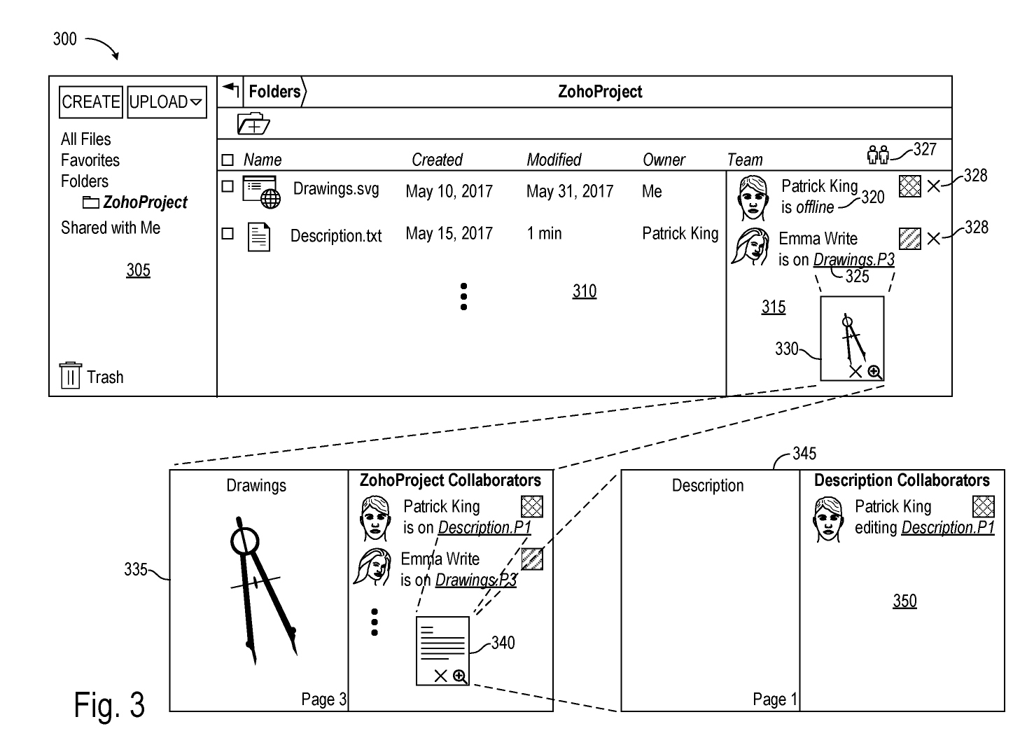

FIG. 3 depicts a window 300 representing a user interface allowing collaborative access to a directory structure and constituent electronic files and folders. At left a window 305 allows a computer user to create and upload documents and lists files and folders for user access. A directory entitled ZohoProject is shown in bold font to show it has been selected. As a consequence, a neighboring window 310 shows a list of files of different file types in the ZohoProject folder. Each of two files, a drawing file Drawings.svg and a text file Description.txt, relate to the same collaborative project (file extensions svg and txt indicate open-source graphics and text file formats). The creator of each file is noted in an Owner column. A window 315 at the right includes a list of collaborators that have been invited to collaborate on the project, and thus have access to the ZohoProject directory. Icons 327 and 328 allow the project owner to invite or disinvite collaborators. Using the collaborators from the example of FIG. 2, Patrick King and Emma Write are each identified by a respective photo and their actions and edits highlighted using a shading or color. A status indicator 320 shows that Patrick King is offline, whereas a hyperlink 325 associated with Emma Write identifies her view of a shared file; in particular, Emma is shown to be viewing page three of file Drawings.svg.

Selecting a collaborator link calls up a PiP window 330 of the Emma Write's view, possibly highlighting her changes. Collaborators can interact with window 330 icons at the lower right of window 330 to close the window, or to expand the window to an editing view 335 of the type detailed above in connection with FIG. 2. In the expanded view 335 a link Description.P1 shows that collaborator Patrick King has come online with access to the first page of the document Description.txt in the ZohoProject directory. Hovering over or selecting link Description.P1 calls up a PiP window 340 showing collaborator King's view. In other embodiments expanded view 335 lists only or preferentially the subset of collaborators assigned to or working on a file rather than those assigned to the entire project. Expanding PiP window 340, for example, opens a view 345 that facilitates collaboration on file Description.txt. The collaborator list 350 shows only Patrick King to illustrate the possibility of different collaborator sets for projects and files. King's status is updated to show that he is editing the document rather than simply viewing it. In other embodiments each collaborator can select what types of status are reported, such as to report edits and not mere views.

Using embodiments of the foregoing method, each collaborator can easily access files and file positions open to other collaborators while working on the same file or collection of files. Any edit made by a collaborator will be sent to the server, applied to the shared file, and propagated to all other file collaborators. The view areas of online collaborators can thus be updated in real time. Changes made offline can be synchronized and annotated as the offline changes are made available to the cloud server. Multiple PiP windows can be displayed simultaneously, as can multiple expanded views. Content can be copied across shared and unshared files, and between portions of the same file. A single user can benefit from e.g. the ability to move between different views and files irrespective of collaborative access, such as to simultaneously edit a report and a related drawing or spreadsheet. Files are related by project in this example but other hierarchies might also be used to define collections of files. Files might be organized by e.g. project, file type, customer, owner, subject matter, or a combination of one or more of these.

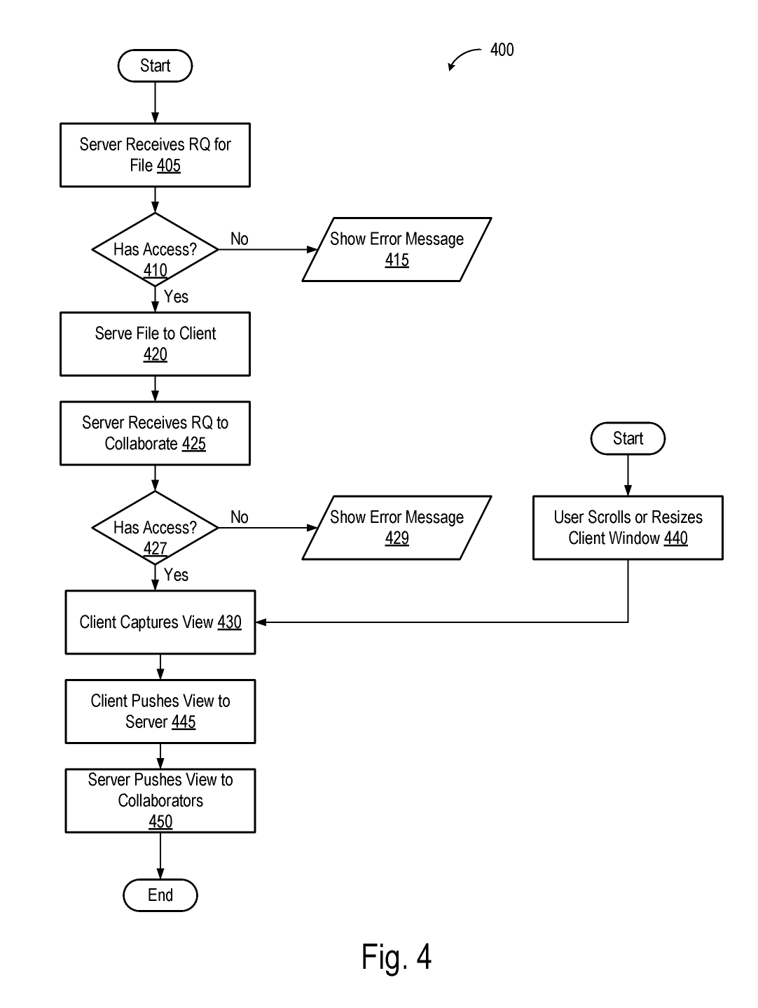

FIG. 4 is a flowchart 400 illustrating how a client device interacts with a server to share users' views in accordance with one embodiment. The process starts when the client requests access to a document, at which time the server receives the request (405). If the server determines that the client lacks access permission, per decision 410, the server issues the client an error message 415. The server otherwise serves the requested file to the client (420). Next, either automatically or by action of the requesting user, the server receives a request from the client to establish a communication channel for collaboration (425). If the server determines that the client lacks collaborative permission, per decision 427, the server issues the client an error message 429. The server otherwise enables collaborative communication and the attendant messaging and editing functionality.

The client, once granted collaborative access, captures the current client view (430) and pushes that view to the server (435). The server then pushes this current client view to any collaborators listed for the file requested in 405 (450). Each time the user scrolls or resizes the active window to change the client view (440) the process returns to 430 so that the updated view is pushed to the server (445) and then to the collaborators (450). The client and server thus work together, responsive to actions taken on the part of the user, to maintain file-view synchronization between the user' client and those of the user's collaborators.

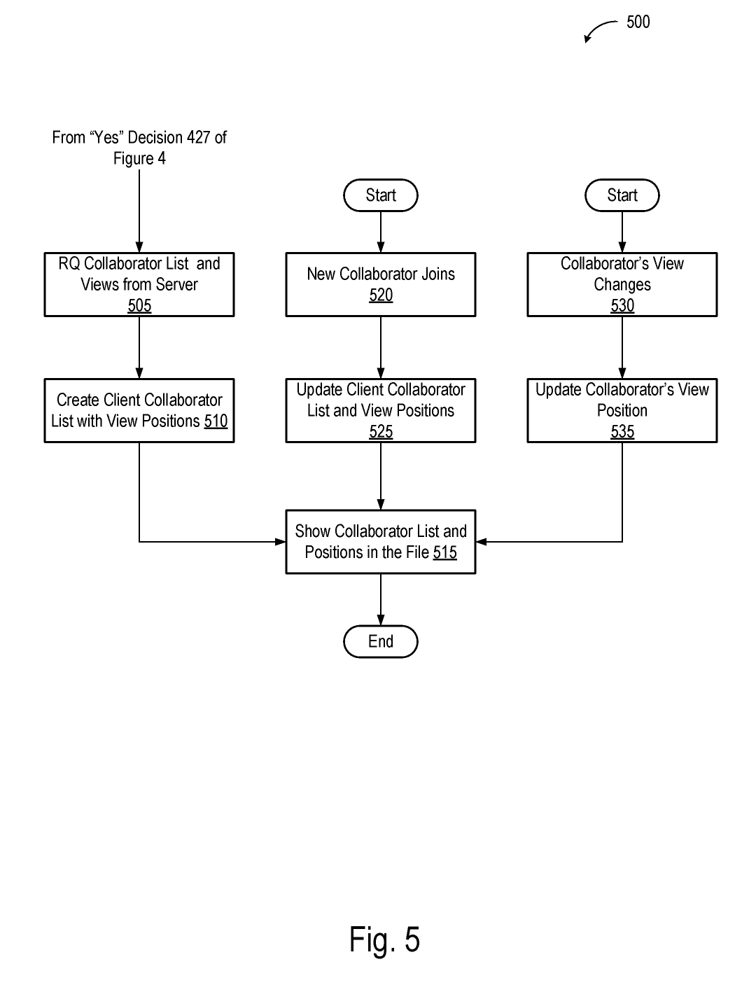

FIG. 5 is a flowchart 500 illustrating how client devices interact with a server to gather and depict lists of collaborators and corresponding collaborator views in accordance with one embodiment. Beginning from a “yes” decision 427 of FIG. 4, the grant by the server of collaborative access, a client requests a list of collaborators and respective views (505). Upon receipt of these data the client creates or updates a local collaborator list with view positions for any collaborators that are accessing the shared file (510). The client then shows the collaborator list with view positions (515).

When a new collaborator accesses an open file, the server adds each new collaborator and collaborator view to the collaborator list (520). The server pushes the new collaborator's name and view position to the connected collaborator clients (525), which allows the clients to show the updated collaborator list with view positions (515). The server, periodically or responsive to view changes 530 reported by collaborator clients, pushes collaborator view updates to the clients (535), which again allows the clients to show the updated collaborator list with view positions (515).

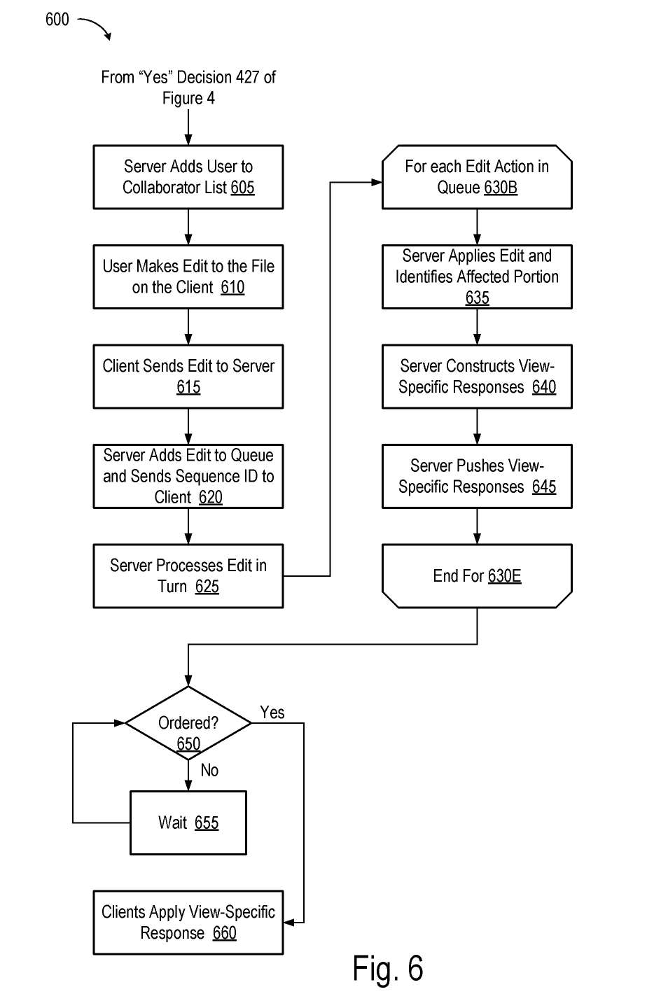

FIG. 6 is a flowchart 600 illustrating how a client device submits an edit to a collaborative file on the server, and how the server manages this edit and those from other collaborators to maintain collaborative file synchronization between clients. Beginning from a “yes” for decision 427 of FIG. 4, the grant by the server of collaborative access, the server adds the user to the collaborator list (605). The user thereafter, by interacting with the client user interface, makes an edit to a file (610). The client sends the edit to the server for incorporation into the collaborative file (615). The server responds by adding the edit to a first-in, first-out (FIFO) edit queue with any other edits submitted by the collaborators and noting a sequence ID indicating the edit's order in the queue (620). The server then processes the edit with the other edits in turn (625).

In the right column of FIG. 6, the server executes a for-loop 630B-630E to apply each edit in the queue in the order received. For each edit, the server makes the specified change to the file and identifies the affected portion of the file (635). Some files, like spreadsheets, may require server-side processing for e.g. formula evaluation, macros, etc. Edits are performed on the server and the changes to affected portions sent to collaborating clients. The server then constructs a view-specific response for each client for which a view resides on the server (640) before pushing the resultant view-specific responses to each client (645).

Returning to the client side, the client maintains the last received sequence ID and compares it with the sequence ID of current view-specific response received from the server. This comparison allows the client to detect whether edits and corresponding view-specific responses are received in the correct order before applying changes to the local instance of a shared file. The client also compares sequence IDs associated with incoming edits and view-specific responses with the sequence ID assigned to the client-side edit in 620 to see whether the client's local edit is reflected in the shared document. Per decision 650, if the sequence is not in order the client waits a few seconds (655) to receive the missing view-specific response or responses before updating the local file and view. If the view-specific response is correctly ordered, then the client applies the view-specific response or responses to the local file and view (660). In some embodiments the client fetches the latest content for the local file and view from the server if it waits (655) times out beyond e.g. a few seconds.

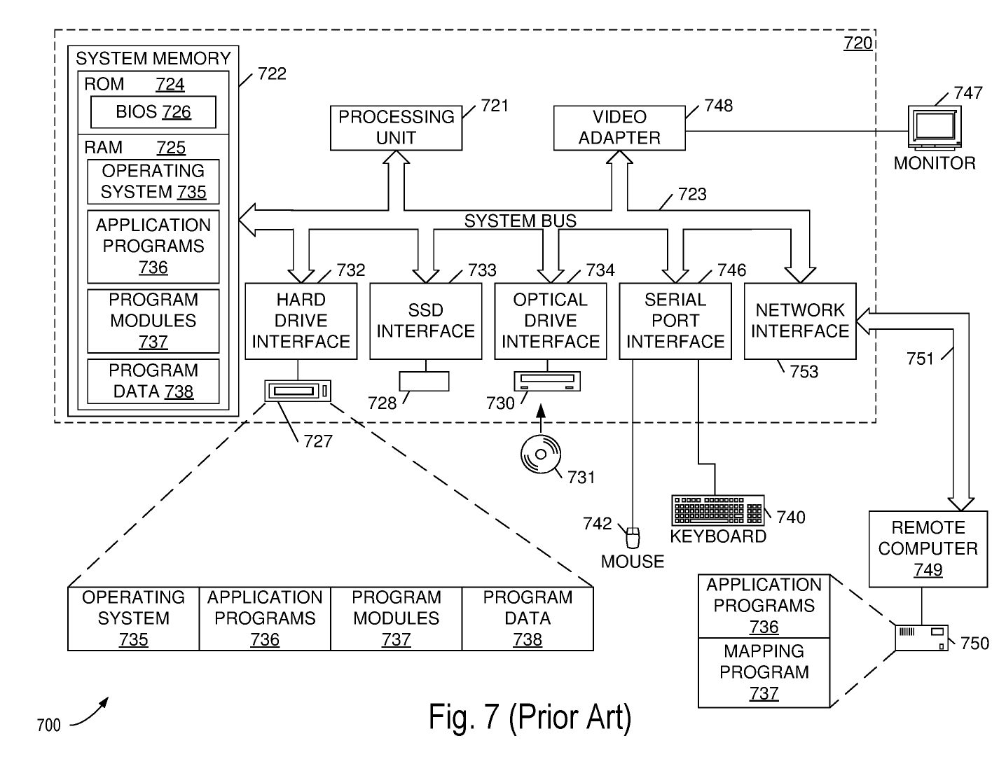

FIG. 7 (prior art) depicts a general-purpose computing system 700 that can serve as a client or a server depending on the program modules and components included. One or more computers of the type depicted in computing system 700 can be configured to perform operations described with respect to FIGS. 1-6. Those skilled in the art will appreciate that the invention may be practiced using other system configurations, including hand-held devices, multiprocessor systems, microprocessor-based or programmable consumer electronics, network PCs, minicomputers, mainframe computers, and the like interconnected to form a larger computing system in support of file collaboration.

Computing system 700 includes a conventional computer 720, including a processing unit 721, a system memory 722, and a system bus 723 that couples various system components including the system memory to the processing unit 721. The system bus 723 may be any of several types of bus structures, including a memory bus or memory controller, a peripheral bus, and a local bus using any of a variety of bus architectures. The system memory includes read only memory (ROM) 724 and random-access memory (RAM) 725. A basic input/output system 726 (BIOS), containing the basic routines that help to transfer information between elements within the computer 720, such as during start-up, is stored in ROM 724. The computer 720 further includes a hard disk drive 727 for reading from and writing to a hard disk, not shown, a solid-state drive 728 (e.g. NAND flash memory), and an optical disk drive 730 for reading from or writing to an optical disk 731 (e.g., a CD or DVD). The hard disk drive 727 and optical disk drive 730 are connected to the system bus 723 by a hard disk drive interface 732 and an optical drive interface 734, respectively. The drives and their associated computer-readable media provide nonvolatile storage of computer readable instructions, data structures, program modules and other data for computer 720. Other types of computer-readable media can be used.

A number of program modules may be stored on the hard disk, solid state disk 728, optical disk 731, ROM 724 or RAM 725, including an operating system 735, one or more application programs 736, other program modules 737, and program data 738. A user may enter commands and information into the computer 720 through input devices such as a keyboard 740 and pointing device 742. Other input devices (not shown) may include a microphone, joystick, game pad, satellite dish, scanner, or the like. These and other input devices are often connected to the processing unit 721 through a serial port interface 746 that is coupled to the system bus, but may be connected by other interfaces, such as a parallel port, game port or a universal serial bus (USB). A monitor 747 or other type of display device is also connected to the system bus 723 via an interface, such as a video adapter 748. In addition to the monitor, computers can include or be connected to other peripheral devices (not shown), such as speakers and printers.

The computer 720 may operate in a networked environment using logical connections to one or more remote computers, such as a remote computer 749. The remote computer 749 may be another computer, a server, a router, a network PC, a peer device or other common network node, and typically includes many or all of the elements described above relative to the computer 720, although only a memory storage device 750 has been illustrated in FIG. 7. The logical connections depicted in FIG. 7 include a network connection 751, which can support a local area network (LAN) and/or a wide area network (WAN). Such networking environments are commonplace in offices, enterprise-wide computer networks, intranets and the Internet.

Computer 720 includes a network interface 753 to communicate with remote computer 749 via network connection 751. In a networked environment, program modules depicted relative to the computer 720, or portions thereof, may be stored in the remote memory storage device. It will be appreciated that the network connections shown are exemplary and other means of establishing a communication link between the computers may be used.

Systems and methods for enhancing file and project collaboration have been described. In the above description, for purposes of explanation, numerous specific details were set forth. It will be apparent, however, that the disclosed technologies can be practiced without these specific details. In other instances, structures and devices are shown in block diagram form. For example, the disclosed technologies are described in some implementations with reference to user interfaces and particular hardware.

Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in any suitable computer-readable storage medium. Furthermore, the disclosed technologies can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters. The processes and displays presented herein may not be inherently related to any particular computer or other apparatus. Various general-purpose systems may be used with programs in accordance with the teachings herein, or it may prove convenient to construct more specialized apparatus to perform the required method steps.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be embodied in other specific forms without departing from the spirit or essential characteristics thereof. Likewise, the particular naming and division of the modules, routines, features, attributes, methodologies, and other aspects are not mandatory or significant, and the mechanisms that implement the present techniques and technologies or its features may have different names, divisions, and/or formats. Furthermore, the modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting.

Variations of these embodiments, and variations in usage of these embodiments, including separate or combined embodiments in which features are used separately or in any combination, will be obvious to those of ordinary skill in the art. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A method for rendering collaborator views of at least one shared electronic file, the collaborator views including a first-collaborator view of a first collaborator and a second-collaborator view of a second collaborator, the method comprising:
rendering the first-collaborator view of the at least one shared electronic file, the first-collaborator view representing a first area of the at least one shared electronic file;
rendering a link to the second-collaborator view of the at least one shared electronic file;
receiving a position update specifying a view position of the at least one shared electronic file by the second collaborator; and
updating the link to the second-collaborator view of the at least one shared electronic file, the updated link to a second area of the at least one shared electronic file encompassing the view position.

2. The method of claim 1, further comprising rendering the second-collaborator view of the at least one shared electronic file responsive to the first collaborator activating the updated link.

3. The method of claim 2, wherein the first-collaborator view encompasses the second-collaborator view.

4. The method of claim 2, further comprising receiving an update of the at least one shared electronic file reflecting an edit of the at least one shared electronic file and updating the second-collaborator view of the at least one shared electronic file responsive to the edit.

5. The method of claim 2, further comprising rendering a second-collaborator cursor indicating an edit position of the second collaborator in the second-collaborator view of the at least one shared electronic file.

6. The method of claim 1, further comprising rendering an identification of the second collaborator with the link to the second-collaborator view.

7. The method of claim 1, wherein the at least one shared electronic file comprises a first file of a first file type and a second file of a second file type.

8. The method of claim 7, wherein the first file comprises a first file extension and the second file comprises a second file extension.

9. The method of claim 1, further comprising displaying the first-collaborator view and the link.

10. The method of claim 1, further comprising updating the first-collaborator view of the at least one shared electronic file responsive to an edit by the first collaborator.

11. A method for sharing collaborator views of at least one shared electronic file, the collaborator views including a first-collaborator view of a first collaborator and a second-collaborator view of a second collaborator, the method comprising:
receiving the first-collaborator view of the at least one shared electronic file, the first-collaborator view representing a first area of the at least one shared electronic file visible to the first collaborator;
sending, to the second collaborator, a first link to the first area of the at least one shared electronic file;
receiving a position update specifying a view position of the first-collaborator view; and
sending, to the second collaborator, a second link to the view position of the first-collaborator view.

12. The method of claim 10, further comprising maintaining a collaborator list listing the first collaborator, the second collaborator, the collaborator list referencing the first-collaborator view and the second-collaborator view.

13. The method of claim 10, further comprising receiving a first edit from the first collaborator and a second edit from the second collaborator, applying the first edit and the second edit to the at least one shared electronic file, and updating at least one of the first-collaborator view and the second-collaborator view responsive to at least one of the first edit and the second edit.

14. The method of claim 11, wherein the at least one shared electronic file comprises a first file of a first file type and a second file of a second file type.

15. The method of claim 14, wherein the first file comprises a first file extension and the second file comprises a second file extension.

16. The method of claim 11, further comprising:
receiving the second-collaborator view of the at least one shared electronic file, the second-collaborator view representing a second area of the at least one shared electronic file visible to the second collaborator; and
sending, to the first collaborator, a second link to the second area of the at least one shared electronic file.

17. The method of claim 16, further comprising receiving a second position update specifying a second view position of the second-collaborator view and sending, to the first collaborator, a third link to the second view position of the second-collaborator view.

18. The method of claim 11, further comprising rendering the first-collaborator view within the second-collaborator view.

19. The method of claim 18, further comprising receiving, from the second collaborator, an activation of the first link, wherein the rendering of the first-collaborator view within the second-collaborator view is responsive to the activation of the first link.

20. A system for sharing collaborator views of at least one shared electronic file, the collaborator views including a first-collaborator view of a first collaborator and a second-collaborator view of a second collaborator, the system comprising:
a server to:
receive the first-collaborator view of the at least one shared electronic file, the first-collaborator view representing a first position in the at least one shared electronic file visible to the first collaborator;
send, to the second collaborator, a first link to the first position in the at least one shared electronic file;
receive a position update specifying a new view position of the first collaborator; and
send, to the second collaborator, a second link to the new view position of the first collaborator.

21. The system of claim 20, the server further to maintain a collaborator list listing the first collaborator, the second collaborator, and referencing the first-collaborator view and the second-collaborator view.

22. The system of claim 20, further comprising:
a first client communicatively coupled to the server and associated with the first collaborator, the first client to receive a view update of the first-collaborator view from the first collaborator and convey the view update to the server as the position update specifying the new view position; and
a second client communicatively coupled to the server and associated with the second collaborator, the second client supporting the second-collaborator view;
the server to update the second-collaborator view with the second link to the new view position of the first collaborator.
